(19) United States
(12) Patent Application Publication
(10) Pub. No.: US 2004/0198313 A1
(43) Pub. Date: Oct. 7, 2004

(54) Method and device of wireless audio/video monitoring based on a mobile communication network

(76) Inventor: Hung-Che Chiu, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 10/407,133

(22) Filed: Apr. 7, 2003

(51) Int. Cl. H04M 11/00; H04M 1/66; H04M 1/68; H04M 3/16

(52) U.S. Cl. 455/404.1; 455/410

(57) ABSTRACT

The present invention also pertains to a wireless audio/video monitoring device using communication means including an image phone used to call a remote communication device, the remote communication device comprising: a frame generator used to capture video image signals; an audio abstracting device used to capture audio signals; a transceiver module used to receive calls and transmit the video image signals/audio signals; and a central processor unit used to control the transceiver module to automatically receive calls from the image phone and to control the frame generator to capture the video image signals/audio signals, then transmitting the video image signals/audio signals to the image phone through the transceiver module.

### BACKGROUND OF THE INVENTION

1. Field of the Invention

The present invention relates generally to a method and device of wireless audio/video monitoring based on a mobile communication network. More particularly, the present invention relates to a method and device of remote audio/video monitoring through a remote communication device capable of capturing video images or audio signals.

2. Description of the Prior Art

In a modern-day society where crime is ever on the increase, people have become more conscious of the importance of security protection of their own property. Typically, residential guarding services are offered by security companies who provide costly household burglarproof systems or home guarding systems that are often installed in people's houses. The home guarding systems are connected to the central computer of the security companies through physical wires or telephone lines. However, the home guarding systems are usually complicated and not afforded by everyone. Further, in most intrusion cases, hosts of the houses are the last one who is informed. As the radio technology advance, wireless household alarm or monitoring systems having burglarproof capability have been developed, which can achieve the goal of implementing audio or video monitoring by radio frequency. Nevertheless, the prior art wireless monitoring systems have RF distance limitation. Typically, the maximum range of the prior art wireless monitoring systems is between 50 meters and 500 meters.

Consequently, there is a need to provide an improved method and guarding device capable of carrying out wireless video/audio monitoring with mobile communication to solve the above-mentioned problems. The present invention takes advantage of 2.5 and 3^{rd} generations mobile communication technology, which enables the mobile phones to transmit audio signals and audio images through high-speed broadband internet.

Taiwan Patent Publish No. 484,774 discloses a household burglarproof system based on a bi-directional transmission mobile phone system. When the intrusion signal is sensed by a sensing device, a GSM control circuit automatically dial a phone number set by a user to start audio surveillance at the site. The user can activate the household burglarproof system by inputting a code to achieve the goal of bi-directional communication. However, the control circuit disclosed in the above-mentioned prior art is complex and the whole system is passive. Furthermore, the above-mentioned prior art household burglarproof system can only carry out audio monitoring. The present invention can actively audio/video monitor the site and has simplified circuit, smaller volume, and the sites under surveillance are randomly changeable, for example, the sites under surveillance can be a residence or a vehicle.

### SUMMARY OF THE INVENTION

According to the claimed invention, a method of wireless audio/video monitoring using communication is provided. A caller uses an image phone to call a remote communication device that has an audio abstracting device or a frame generator therein. The method comprising the steps of:

(a) the remote communication device prompting the image phone to input password;

(b) the caller inputting a password through the image phone;

(c) the remote communication device checking the password, and if the password is correct, then activating the audio abstracting device or the frame generator; and

(d) the audio abstracting device capturing voice or the frame generator capturing audio images, and the captured images or sound signals are transmitted to the image phone through the remote communication device, such that the caller can wireless monitor audio or video.

The present invention also pertains to a wireless audio/video monitoring device using communication means including an image phone used to call a remote communication device, the remote communication device comprising: a frame generator used to capture video image signals; an audio abstracting device used to capture audio signals; a transceiver module used to receive calls and transmit the video image signals/audio signals; and a central processor unit used to control the transceiver module to automatically receive calls from the image phone and to control the frame generator to capture the video image signals/audio signals, then transmitting the video image signals/audio signals to the image phone through the transceiver module.

Other advantages and novel features of the invention will become more clearly and readily apparent from the following detailed description when taken in conjunction with the accompanying drawings.

### BRIEF DESCRIPTION OF THE DRAWINGS

FIG. 1 is a block diagram showing an audio or video monitoring system based on mobile communication according to one preferred embodiment of the present invention.

FIG. 2 is a block diagram depicting the circuit of the audio or video monitoring system based on mobile communication according to one preferred embodiment of the present invention.

FIG. 3 is a circuit diagram showing the amplifier circuit or the image amplifying circuit according to the preferred embodiment of the present invention.

FIG. 4 is a flowchart depicting the process of the present invention.

FIG. 5 is a typical view showing the remote communication device connected to a computer.

### DETAILED DESCRIPTION OF THE PREFERRED EMBODIMENT

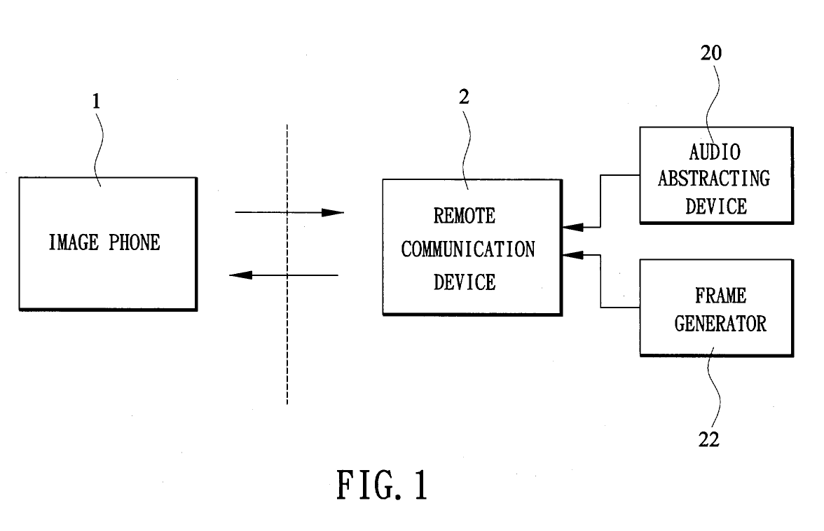

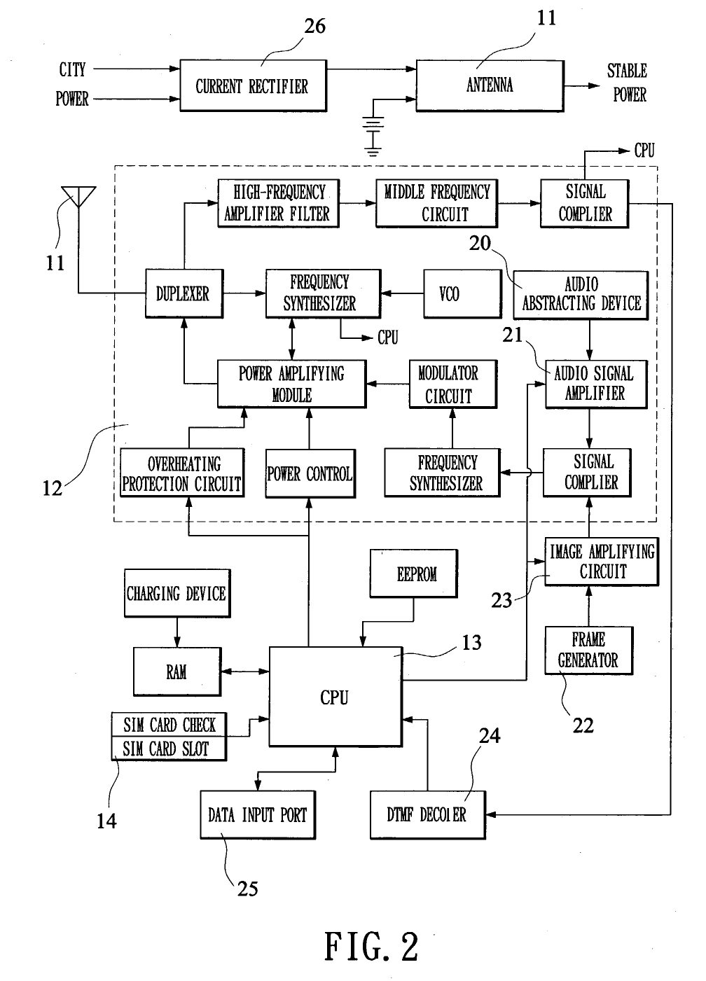

Please refer to FIG. 1 and FIG. 2. FIG. 1 is a block diagram showing an audio or video monitoring system based on mobile communication according to one preferred embodiment of the present invention. FIG. 2 is a block diagram depicting the circuit of the audio or video monitoring system based on mobile communication according to one preferred embodiment of the present invention. The present invention uses an image phone 1 to call a remote communication device 2. The image phone 1 may be a cable digital image phone or a mobile phone capable of displaying video images. The remote communication device 2 may be a mobile phone or an image phone equipped with an audio abstracting device 20 or a frame generator 22 such that the images or voice signals at the site under surveillance can be transmitted to the image phone. In FIG. 2, the remote communication device 2 is, by way of example, a mobile phone. According to this invention, the remote communication device 2 is a typical mobile phone with a frame generator except that it does not have certain outer interfaces such as a screen, vibration ring and character ROM, while it keeps devices such as antenna 11, transceiver module 12, central processing unit (CPU) 13 and SIM card (user identification module) slot 14. The antenna 11 is connected to the transceiver module 12 to automatically receive the call from the image phone 1 and to transmit abstracted images or voice signals at the site under surveillance by the audio abstracting device 20 or frame generator 22 to the image phone 1. The present invention is based on a low-power radio signal transceiver following 2.5 or 3^{rd} generation mobile phone standards with some changes on interfaces. Accordingly, the SIM card and RF transmit power, digital signal complier and SIM card slot follow the standards such that after the SIM card is inserted into the remote communication device 2, normal on-line register and normal standby status can be ensured.

The remote communication device 2 of the present invention uses the audio abstracting device 20 such as a microphone that is electrically connected to an amplifier circuit 21 to increase sound recording sensitivity. In addition, the remote communication device 2 of the present invention uses the frame generator 22 such as a CCD that is electrically connected to an image amplifying circuit 23 to photograph image signals at the site. A DTMF decoder 23 is disposed in the in-line circuit to unscramble the in-line DTMF code sent from a phone inputted by a user. By doing this, the remote communication device 2 with SIM card becomes a communication device that is capable of receiving calls but cannot call out. The CPU is revised to automatically receive calls. When a call is put one line, the amplifier circuit 21 and the image amplifying circuit 23 is remained unopened temporarily, but only prompting “input safety password” to the caller. Only if the caller inputs correct password through phone buttons in a pre-selected time period as the image phone 1 is put on line, the CPU 13 will actuate the amplifier circuit 21 and the image amplifying circuit 23 to allow the image phone 1 to monitor audio/video at the site.

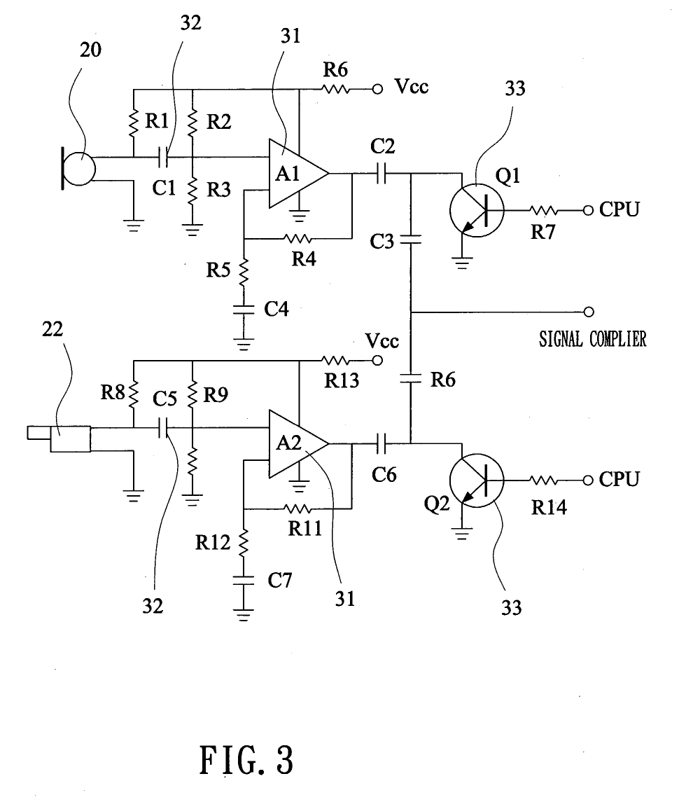

Please refer to FIG. 3. FIG. 3 is a circuit diagram showing the amplifier circuit 21 or the image amplifying circuit 23 according to the preferred embodiment of the present invention. The amplifier circuit 21 or the image amplifying circuit 23 includes an operational amplifier 31 having a capacitor 32 disposed at its input end. The capacitor 32 is connected to the audio abstracting device 20 or the frame generator 22. The captured sound signals or image signals are pre-amplified by the operational amplifier 31. A transistor 33 is disposed at the output end of the operational amplifier 31 to turn on or turn off the amplifier circuit 21 or the image amplifying circuit 23.

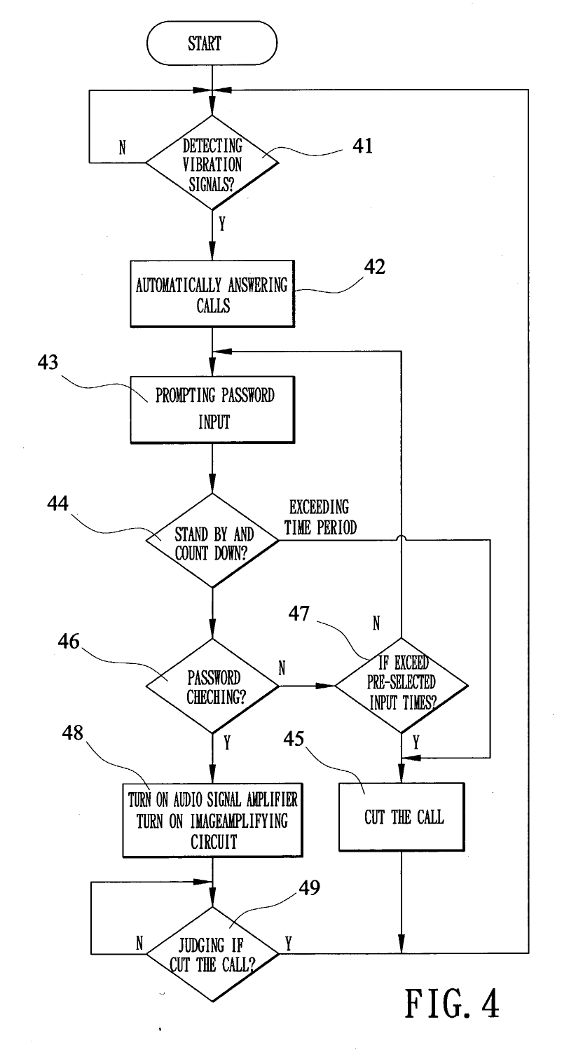

Please refer to FIG. 4. FIG. 4 is a flowchart depicting the process of the present invention. As shown in FIG. 4, the present invention uses the image phone 1 to call the remote communication device 2, which constantly detects vibration ring signal (Step 41). When the vibration ring signal 41 is detected, the remote communication device 2 automatically answers the call (Step 42), but leaving the amplifier circuit 21 or the image amplifying circuit 23 unopened, and at the same time, prompting the caller to input safety password (Step 43). The prompt may be a voice message, characters, or images. At this phase, the remote communication device 2 is one standby awaiting the caller to input password with time counting down (Step 44). If the caller does not enter the password in time, the remote communication device 2 automatically cut the line (Step 45). If the caller enters the password in time, the password is checked (Step 46). If the password is wrong, the remote communication device 2 automatically judges the times that the password inputted is wrong and compares with the pre-selected input times (Step 47). When the accumulated wrong password input-times exceeds the pre-selected value, the call is cut. If the caller input correct password within the pre-selected input time period, the remote communication device 2 turn on the amplifier circuit 21 or the image amplifying-circuit 23 (Step 48) to allow the caller to monitor the sound or images at the site. The on-line surveillance will not stop until the caller hangs up the call (Step 49).

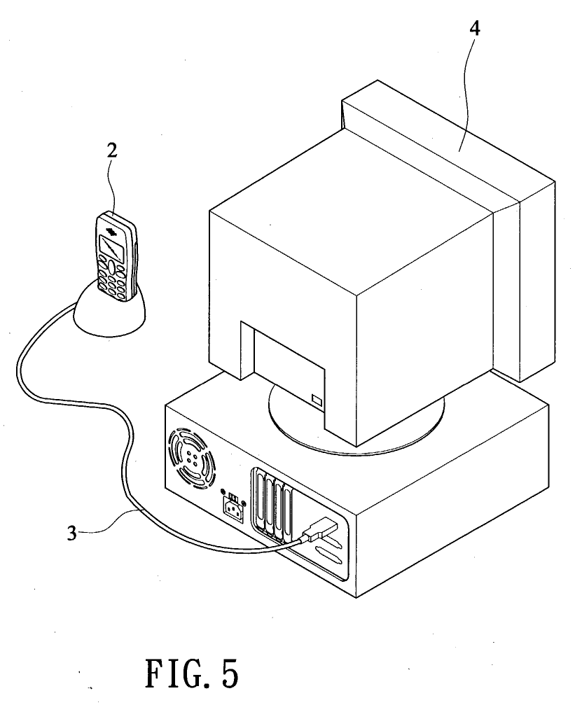

The settings of the internal system of the remote communication device 2 or changes of the password that is needed when establishing a connection can be inputted through an accessory data input port 25. Referring to FIG. 5, this can be done by connect to the communication interface of a computer though a connecting line, wherein the communication interface of the computer may be RS-232 or USB interfaces.

Further, the remote communication device 2 of this invention can be powered by external power sources or commercial batteries. When long-term standby is needed, city power may be used. The city power passes through a current rectifier 26 and then a power regulator 27 to provide stable power source. Since the present invention has no screen and vibration ring, the size of the device is shrunk and the device can be embedded in daily used electric apparatuses such as power extension lines, emergence light devices, or electronic clocks and so on and the device can use the power source of the electric apparatuses.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of wireless audio/video monitoring using communication, wherein a caller uses an image phone to call a remote communication device that has an audio abstracting device or a frame generator therein, the method comprising the steps of:
(a) the remote communication device prompting the image phone to input password;
(b) the caller inputting a password through the image phone;
(c) the remote communication device checking the password, and if the password is correct, then activating the audio abstracting device or the frame generator; and
(d) the audio abstracting device capturing voice or the frame generator capturing audio images, and the captured images or sound signals are transmitted to the image phone through the remote communication device, such that the caller can wireless monitor audio or video.

2. The method as claimed in claim 1 wherein before the step (a), the method further comprises:
the remote communication device constantly detecting a vibration signal; and
if the vibration signal is detected, automatically answering the call.

3. The method as claimed in claim 1 wherein the prompting of the step (a) is through voice messages, characters, or images.

4. The method as claimed in claim 1 wherein the input of password of the step (b) must be finished within a pre-selected time period, and if exceeding the pre-selected time period, the call is cut.

5. The method as claimed in claim 1 wherein the password checking by the remote communication device of the step (c) has pre-determined check times, and if exceeding the pre-determined check times, the call is cut.

6. A wireless video monitoring device using communication means including an image phone used to call a remote communication device, the remote communication device comprising:
a frame generator used to capture video image signals;
a transceiver module used to receive calls and transmit the video image signals; and
a central processor unit used to control the transceiver module to automatically receive calls from the image phone and to control the frame generator to capture the video image signals, then transmitting the video image signals to the image phone through the transceiver module.

7. The wireless monitoring device as claimed in claim 6 wherein the image phone is a cable digital image phone or a mobile phone capable of displaying video images.

8. The wireless video monitoring device as claimed in claim 6 wherein the frame generator is a CCD.

9. The wireless video monitoring device as claimed in claim 6 further comprising an image amplifying circuit connected to the frame generator to amplify the video image signals and control the on/off of the frame generator.

10. The wireless video monitoring device as claimed in claim 6 further comprising an antenna connected to the transceiver module.

11. The wireless video monitoring device as claimed in claim 6 further comprising a SIM card slot for adapting a SIM card, which is used to identify user id.

12. The wireless video monitoring device as claimed in claim 6 further comprising a DTMF decoder used to unscramble DTMF codes inputted through the image phone.

13. The wireless video monitoring device as claimed in claim 6 further comprising a data input port used to change internal settings of the remote communication device or password.

14. A wireless audio monitoring device using communication means including the use of a phone to call a remote communication device, the remote communication device comprising:
an audio abstracting device used to capture audio signals;
a transceiver module used to receive calls and transmit the audio signals; and
a central processor unit used to control the transceiver module to automatically receive calls from the phone and to control the audio abstracting device to capture the audio signals, then transmitting the audio signals to the phone through the transceiver module.

15. The wireless audio monitoring device as claimed in claim 14 wherein the audio abstracting device is a microphone.

16. The wireless audio monitoring device as claimed in claim 14 further comprising an audio signal amplifying circuit connected to the audio abstracting device to increase audio recording sensitivity and control the on/off of the audio abstracting device.

17. The wireless audio monitoring device as claimed in claim 14 further comprising an antenna connected to the transceiver module.

18. The wireless audio monitoring device as claimed in claim 14 further comprising a SIM card slot for adapting a SIM card, which is used to identify user id.

19. The wireless audio monitoring device as claimed in claim 14 further comprising a DTMF decoder used to unscramble DTMF codes inputted through the phone.

20. The wireless audio monitoring device as claimed in claim 14 further comprising a data input port used to change internal settings of the remote communication device or password.
